(19) United States
(12) Patent Application Publication
(10) Pub. No.: US 2024/0355529 A1
(43) Pub. Date: Oct. 24, 2024

(54) MULTILAYER CONDUCTOR, METHODS FOR THE MANUFACTURE THEREOF, AND ASSEMBLY COMPRISING THE MULTILAYER CONDUCTOR

(71) Applicant: ROGERS CORPORATION, Chandler, AZ (US)

(72) Inventors: Karl Sprentall, Woburn, MA (US); Vitali Judin, Eggenstein-Leopoldshafen (DE); Rebecca Agapov, Bear, DE (US); William Blasius, Charlton, MA (US); Nazeef Azam, Shrewsbury, MA (US)

(21) Appl. No.: 18/642,128

(22) Filed: Apr. 22, 2024

Related U.S. Application Data
(60) Provisional application No. 63/461,399, filed on Apr. 24, 2023.

(51) Int. Cl. H01F 27/28; H01F 41/04

(52) U.S. Cl. CPC H01F 27/2804; H01F 41/041

(57) ABSTRACT

A multilayer conductor includes a conductor layer and a dielectric layer on the conductor layer. The dielectric layer includes a polymer composition having a dissipation factor (Df) of less than 0.001 and includes a cyclic olefin copolymer, a transoctenamer rubber, syndiotactic polystyrene, a polymethylpentene olefin copolymer, or a combination thereof. The materials described herein can advantageously provide an improved adhesive strength between the conductor and the dielectric layer. Methods for the manufacture of the multilayer conductor are also described. The multilayer conductor can be useful in the preparation of magnetic self-resonant structures.

### CROSS REFERENCE TO RELATED APPLICATION

This application claims priority to U.S. Provisional Patent Application No. 63/461,399, filed on Apr. 24, 2023, the content of which is hereby incorporated by reference in its entirety.

### BACKGROUND

Inductive wireless power transfer provides a method for powering and recharging mobile electronic devices, such as smartphones. It is desirable for this technology to be highly efficient and easy to manufacture, for example with an inexpensive, high-volume method. Such technology can enable powering and recharging of high-power items including electric passenger vehicles, forklifts, material handling equipment, busses, or automated guided vehicles.

Existing methods to enable inductive wireless power transfer can use a magnetic self-resonant structure. These structures may include a plurality of conductors which are patterned and bonded together, maintaining the same z-axis distance between each set of conductors. Previous materials used to prepare such materials have been limited due to the material requirements (e.g., electrical performance and dielectric strength performance) for the specific application.

It would therefore be desirable to expand the scope of materials capable of being used for this application. It would be a further advantage to improve the adhesion between the metal of the conductor and the dielectric layer. Such structures may be particularly well suited for use as magnetic self-resonant structures for inductive wireless power transfer applications.

### SUMMARY

A multilayer conductor comprises a conductor layer and a dielectric layer on the conductor layer, wherein the dielectric layer comprises a polymer composition having a dissipation factor (Df) of less than 0.001 and comprising a cyclic olefin copolymer, a transoctenamer rubber, syndiotactic polystyrene, a polymethylpentene olefin copolymer, or a combination thereof; and wherein an interface between the conductor layer and the dielectric layer has a peel strength of at least 5 pounds of force per linear inch (PLI) (0.88 kilonewtons per meter).

A method for the manufacture of the multilayer conductor comprises: applying a coating composition comprising a polymer composition having a dissipation factor (Df) of less than 0.001 and comprising a cyclic olefin copolymer, a transoctenamer rubber, syndiotactic polystyrene, a polymethylpentene olefin copolymer, or a combination thereof, and a solvent, to the first layer; removing the solvent to provide a coated conductor having a surface coated with the polymer composition; contacting the coated conductor with the dielectric layer to provide a composite comprising the conductor layer and the dielectric layer, wherein a coated surface of the coated conductor directly contacts the dielectric layer; wherein the dielectric layer comprises the same polymer composition as the coating composition.

Another aspect of the present disclosure is an assembly comprising the multilayer conductor, preferably wherein the assembly is a magnetic self-resonant structure.

The above described and other features are exemplified by the following figures and detailed description.

### BRIEF DESCRIPTION OF THE DRAWINGS

The following figures represent exemplary embodiments.

FIG. 1. shows a top view of a magnetic self-resonant structure (MSRS) coil having a patterned conductor bonded to a dielectric material.

FIG. 2 shows a cross-sectional view of a MSRS coil having multiple layers of patterned conductor structures bonded to a dielectric material.

FIG. 3 shows a coated conductor contacting a dielectric layer to provide a composite according to an aspect of the present disclosure.

FIG. 4 shows a first and second multilayer conductor structure which can be laminated to provide a final multilayer conductor structure according to an aspect of the disclosure.

### DETAILED DESCRIPTION

A significant challenge in providing bonded conductor-dielectric structures is bonding the resin to the conductor. The present inventors have unexpectedly discovered that particular materials can be used as dielectric layers in a multilayer conductor structure when prepared according to the present disclosure. In particular, the present inventors have advantageously developed a method of preparing a multilayer conductor where the conductor is pre-coated with a particular thin film layer. The presence of the thin film layer can act as an adhesive to improve the bond between the conductor and the dielectric layer. In a further advantageous feature, due to the range of dielectric constants of the dielectric materials found to be useful herein, the number of layers required to achieve the electrical resonance of the target operating frequency can be modified. A significant improvement is therefore provided by the present disclosure.

Accordingly, an aspect of the present disclosure is a multilayer conductor. The multilayer conductor comprises a conductor layer and a dielectric layer on the conductor layer. When more than one conductor layer or dielectric layer are present, they are arranged in an alternating manner. In an aspect, the multilayer conductor comprises two conductor layers and a dielectric layer disposed there between. In an aspect, the multilayer conductor comprises two or more conductors and two or more dielectric layers, wherein the conductor layers and the dielectric layers are arranged in an alternating manner.

The dielectric layer of the multilayer conductor comprises a polymer composition. The polymer composition has a dissipation factor of less than 0.001. The polymer composition comprises a cyclic olefin copolymer, a transoctenamer rubber, syndiotactic polystyrene, a polymethylpentene olefin copolymer, or a combination thereof.

In some aspects, the polymer composition can optionally further comprise a reinforcing filler. The reinforcing filler can generally comprise any suitable reinforcing filler. In an aspect, the reinforcing filler can have a high aspect ratio (e.g., an aspect ratio of greater than 1:1, or greater than 5:1, or greater than 10:1, or greater than 20:1, or greater than 40:1). For example, the reinforcing filler can comprise nanofibers or nanoplates. Preferred reinforcing agents are not electrically conductive. Non-conductive particles are defined as those with a resistivity of greater than 1×108 ohm. In an aspect, an electrically conductive filler can be excluded from the core layer.

Exemplary reinforcing fillers can include, for example, mica, quartz, glass, calcium silicate, aluminum silicate, zirconium silicate, aluminum silicates, titanium dioxide, barium titanate, calcium carbonate, calcium sulfate, ferric oxide, lithium aluminum silicate, silicon carbide, magnesium silicate, zirconium oxide, or a combination thereof. The reinforcing fillers can optionally be surface treated to improve adhesion and dispersion with the core layer.

In an aspect, the reinforcing filler can preferably be a fibrous reinforcing filler, for example, glass fibers. Glass fibers can include E, A, C, ECR, R, S, D, or NE glasses, or the like. The reinforcing fillers can be provided in the form of monofilament or multifilament fibers and can be used individually or in combination with other types of fiber, through, for example, co-weaving or core/sheath, side-by-side, orange-type or matrix and fibril constructions, or by other methods known to one skilled in the art of fiber manufacture. Fibrous fillers can be supplied in the form of, for example, rovings, woven fibrous reinforcements, such as 0-90 degree fabrics or the like; non-woven fibrous reinforcements such as continuous strand mat, chopped strand mat, tissues, papers and felts or the like. In an aspect, when present, the reinforcing filler can comprise glass fibers.

When present, reinforcing fillers can be included in the polymer composition in amounts of, for example, greater than 0 to 30 weight percent, or 1 to 30 weight percent or 5 to 25 weight percent, or 10 to 20 weight percent, each based on the total weight of the polymer composition of the dielectric layer.

In a specific aspect, the dielectric layer comprises a cyclic olefin copolymer. Cyclic olefin copolymers generally comprise recurring monomer units derived from cyclic olefins and acyclic olefins, or ring-opening polymers based on cyclic olefins. Exemplary cyclic olefins can include, but are not limited to, norbornene-based olefins, tetracyclododecene-based olefins, dicyclopentadiene-based olefins, and derivatives thereof. Derivatives include alkyl (preferably C₁₋₂₀ alkyls, more preferably C₁₋₁₀ alkyls), alkylidene (preferably C₁₋₂₀ alkylidenes, more preferably C₁₋₁₀ alkylidenes), aralkyl (preferably C₆₋₃₀ aralkyls, more preferably C₆-18 aralkyls), cycloalkyl (preferably C₃₋₃₀ cycloalkyls, more preferably C₃₋₁₈ cycloalkyls), ether, acetyl, aromatic, ester, hydroxy, alkoxy, cyano, amide, imide, and silyl-substituted derivatives.

In an aspect, the cyclic olefin copolymer can have a melt volume flow rate of 1 to 50 cm³ per 10 minutes. In an aspect, the cyclic olefin copolymer can have a glass transition temperature of greater than 125° C. In an aspect, the cyclic olefin copolymer can have a relative permittivity of greater than 2 at 1 to 10 kilohertz (kHz). In an aspect, the cyclic olefin copolymer can have a dissipation factor of less than 0.001 at 1 gigahertz (GHz).

In a specific aspect, the cyclic olefin copolymer can be an ethylene/norbornene cyclic olefin copolymer. In an aspect, the cyclic olefin copolymer can have a melt flow rate of 40 to 50 grams per 10 minutes (g/10 minutes) at 260° C. under a 2.16 kilogram load, and a glass transition temperature of 270 to 275° C., determined according to ISO 11357-1. In an aspect, the cyclic olefin copolymer can have a melt volume rate of 1 to 10 cubic centimeters per 10 minutes (cm³/10 minutes) at 260° C. under a 2.16 kilogram load according to ISO 1133, and a glass transition temperature of 150 to 165° C., determined according to ISO 11357-1.

In an aspect, the dielectric layer can comprise a combination of two or more cyclic olefin copolymers. For example, in an aspect, the dielectric layer can comprise a first cyclic olefin copolymer and a second cyclic olefin copolymer. The first and second cyclic olefin copolymer can differ in chemical composition, molecular weight, or a combination thereof. In a specific aspect, the first cyclic olefin copolymer and the second cyclic olefin copolymer can be present in a weight ratio of 1:99 to 99:1, or 5:95 to 95:5, or 5:95 to 50:50, or 5:95 to 20:80, or 5:95 to 15:85.

In a specific aspect, the dielectric layer can comprise a first cyclic olefin copolymer having a melt volume rate of 5 to 15 cm³/10 minutes at 260° C. under a 2.16 kilogram load according to ISO 1133, and a glass transition temperature of 135 to 150° C., determined according to ISO 11357-1; and a second cyclic olefin copolymer having a melt volume rate of 5 to 15 cm³/10 minutes at 260° C. under a 2.16 kilogram load according to ISO 1133, and a melt temperature of 80 to 900° C., determined according to ISO 11357. In an aspect, the first cyclic olefin copolymer can comprise an ethylene-norbornene copolymer. In an aspect, the second cyclic olefin copolymer can be a cyclic olefin copolymer elastomer. In an aspect, the second cyclic olefin copolymer can comprise an ethylene-norbornene copolymer.

In an aspect, the dielectric layer can comprise a cyclic olefin copolymer in combination with a polymer different from the cyclic olefin copolymer. When present, the polymer different from the cyclic olefin polymer has a dissipation factor (Df) of less than 0.001 and preferably comprises a transoctenamer rubber, syndiotactic polystyrene, a polymethylpentene olefin copolymer, or a combination thereof. In a specific aspect, the polymer different from the cyclic olefin polymer comprises a transoctenamer rubber as further discussed below. When present in combination, the cyclic olefin copolymer and the polymer different from the cyclic olefin polymer can be present in the dielectric layer in a weight ratio of 10:90 to 90:10, or 50:50 to 90:10, or 60:40 to 80:20, or 65:35 to 75:25.

Exemplary cyclic olefin copolymers are commercially available, for example as TOPAS 5013S-04, TOPAS 5013S-04, TOPAS 6013M-07, and TOPAS ELASTOMER E-140 from TOPAS Advance Polymers, those under the tradename APEL from Mitsui Chemical Co., those under the tradename ZEONEX from ZEON Corp., those under the tradename ZEONOR from ZEON Corp., and those under the tradename ARTON from JSR Corp.

In an aspect, the dielectric layer can comprise a transoctenamer rubber. As used herein, transoctenamer rubber refers to a resin prepared by polymerization of cyclooctene, in which one double bond is located between two units of eight repeated methylene groups. The term “trans” refers to the trans-cis ratio of the double bonds of the resin. As used herein, a transoctenamer rubber has a high trans-content, for example a trans: cis ratio of at least 50:50, or at least 60:40, or at least 70:30, or at least 75:25, or 70:30 to 90:10, or 75:25 to 90:10, or 75:25 to 85:15. As will be understood by the skilled person, the trans: cis ratio of the double bonds influences the crystallinity of the polyoctenamer. In general, a greater crystallinity and consequently a higher melting temperature is obtained with increasing trans-content. In an aspect, the transoctenamer rubber can have a crystallinity of at least 10%, or at least 20%, or at least 25%, or 20 to 40%, or 25 to 40%. The transoctenamer rubber can have a melting point of greater than 40° C., or greater than 50° C., or 50 to 100° C., or 50 to 80° C., or 50 to 60° C.

Processes for preparing a polyoctenamer resin are disclosed for example in the documents U.S. Pat. Nos. 3,798,185, 3,849,509, 4,095,033, 3,804,804 and 3,836,593, the contents of which are hereby incorporated by reference in their entirety for all purposes.

In a specific aspect, the transoctenamer rubber can have a trans content of 70 to 90%, or 75 to 85%, a molecular weight of 75,000 to 125,000 grams per mole (g/mol), or 90,000 to 110,000 g/mol, and a melting temperature of 50 to 60° C.

Transoctenamer rubbers suitable for use in the dielectric layer according to the present disclosure are commercially available, for example under the tradename VESTENAMER from Evonik.

In an aspect, the dielectric layer can comprise the transoctenamer rubber in combination with a polymer different from the transoctenamer rubber. When present, the polymer different from the transoctenamer rubber has a dissipation factor (Df) of less than 0.001 and preferably comprises a cyclic olefin copolymer, syndiotactic polystyrene, a polymethylpentene olefin copolymer, or a combination thereof. For example, the dielectric layer can comprise the cyclic olefin copolymer and the transoctenamer rubber. When present in combination, the cyclic olefin copolymer and transoctenamer rubber can be present in the dielectric layer in a weight ratio of cyclic olefin copolymer:transoctenamer rubber of 10:90 to 90:10, or 50:50 to 90:10, or 60:40 to 80:20, or 65:35 to 75:25.

In an aspect the dielectric layer can comprise the syndiotactic polystyrene. The syndiotactic polystyrene can be a syndiotactic polystyrene homopolymer or copolymer. As used herein, the term “syndiotactic” refers to polymers having a stereoregular structure of greater than or equal to 80% syndiotactic, preferably greater than or equal to 90% syndiotactic, or greater than or equal to 95% syndiotactic, or 80 to 100% syndiotactic, or 90 to 100% syndiotactic, or 95 to 100% syndiotactic of a racemic triad, for example as determined by ¹³C nuclear magnetic resonance (NMR) spectroscopy. Typical polymerization processes for producing syndiotactic polystyrene are well known in the art and are described, for example, in U.S. Pat. Nos. 4,680,353, 5,066,741, 5,206,197, and 5,294,685, the contents of each of which is hereby incorporated by reference.

Suitable syndiotactic polystyrenes are commercially available, for example including those under the trade name XAREC from Idemitsu.

In a specific aspect, the dielectric layer can comprise the syndiotactic polystyrene and a reinforcing filler, preferably glass fibers. When present, the reinforcing filler can be present in an amount of greater than 0 to 30 weight percent, or 1 to 30 weight percent or 5 to 25 weight percent, or 10 to 20 weight percent, each based on the total weight of the syndiotactic polystyrene and the reinforcing filler.

In an aspect, the dielectric layer can comprise a polymethylpentene olefin copolymer. The polymethylpentene olefin copolymer comprises a 4-methyl-1-pentene homopolymer or a 4-methyl-1-pentene/α-olefin random copolymer containing 80 to 99.9 weight percent, preferably 90 to 99.9 weight percent, of repeating units derived from 4-methyl-1-pentene and 0.1 to 20 weight percent, preferably 0.1 to 10 weight percent of an α-olefin of 2 to 20, preferably 6 to 20 carbon atoms. The polymethylpentene olefin copolymer described herein is unmodified. By the term “unmodified” it is meant that the polymer has no grafting agents acting upon it in order to modify its polymer matrix.

In the case of the 4-methyl-1-pentene/α-olefin random copolymer, the α-olefin copolymerized with 4-methyl-1-pentene can be an α-olefin of 2 to 20, preferably 6 to 20 carbon atoms, such as ethylene, propylene, 1-butene, 1-hexene, 1-octene, 1-decene, 1-dodecene, 1-tetradecene, 1-hexadecene, 1-octadecene or 1-eicosene. For copolymerization with 4-methyl-1-pentene, these α-olefins may be used singly or two or more kinds may be used in combination.

In an aspect, the polymethylpentene olefin polymer can have a melt flow rate (MFR: ASTM D1238, 260° C., 5.0 kilogram (kg) load) of 0.1 to 200 grams per 10 minutes (g/10 min), preferably 1 to 150 g/10 min. In an aspect, the polymethylpentene olefin polymer can have a dielectric constant of greater than 1 at 1 megahertz (MHz), preferably greater than or equal to 2 at 1 MHz. In an aspect, the polymethylpentene olefin polymer can have a dissipation factor of less than 0.001 at 1 GHz, or less than 0.0005 at 1 KHz.

In a specific aspect, the polymethylpentene olefin copolymer can be a 4-methyl-1-pentene/α-olefin random copolymer containing 90 to 95 weight percent, based on the total weight of the copolymer, of repeating units derived from 4-methyl-1-pentene, and 5 to 10 weight percent of repeating units derived from C₁₆₋₁₈ olefins. The polymethylpentene olefin copolymer can have a melt flow rate of 20 to 25 grams per 10 minutes, determined at 260° C. under a 5 kilogram load.

Exemplary polymethylpentene olefin copolymers suitable for use in the present disclosure include those available as TPXMX001, MX002, MX004, MX021, MX321, RT18 and DX845 from Mitsui Chemicals, Inc.

In an aspect, the dielectric layer can minimize or exclude polymers other than the cyclic olefin copolymer, transoctenamer rubber, syndiotactic polystyrene, and polymethylpentene olefin copolymer. For example, any suitable polymer other than the cyclic olefin copolymer, transoctenamer rubber, syndiotactic polystyrene, and polymethylpentene olefin copolymer can be present in the dielectric layer in an amount of 5 weight percent or less, or 1 weight percent or less, or 0.1 weight percent or less, each based on the total weight of the dielectric layer. In an aspect, polymers other than the cyclic olefin copolymer, transoctenamer rubber, syndiotactic polystyrene, and polymethylpentene olefin copolymer can be excluded from the dielectric layer.

In an aspect, the dielectric layer can comprise a crosslinked portion at an interface of the dielectric layer and the conductor layer. For example, the crosslinked portion can extend up to 25 micrometers into the dielectric layer from the interface. In an aspect, when present, the crosslinked portion can extend 5 to 25 micrometers into the dielectric layer from the interface.

Advantageously, the interface between the conductor layer and the dielectric layer can have a significantly improved adhesive strength. For example, the interface between the conductor layer and the dielectric layer can have a peel strength of at least 5 pounds of force per linear inch (PLI) (876 newtons per meter).

The multilayer conductors described herein can generally have any suitable shape, including, for example, rectangular, tubular, cylindrical, “C” shape”, or wound in a spiral shape. In an aspect, the multilayer conductor can be wound in a spiral shape, for example, for use in an inductor or a transformer.

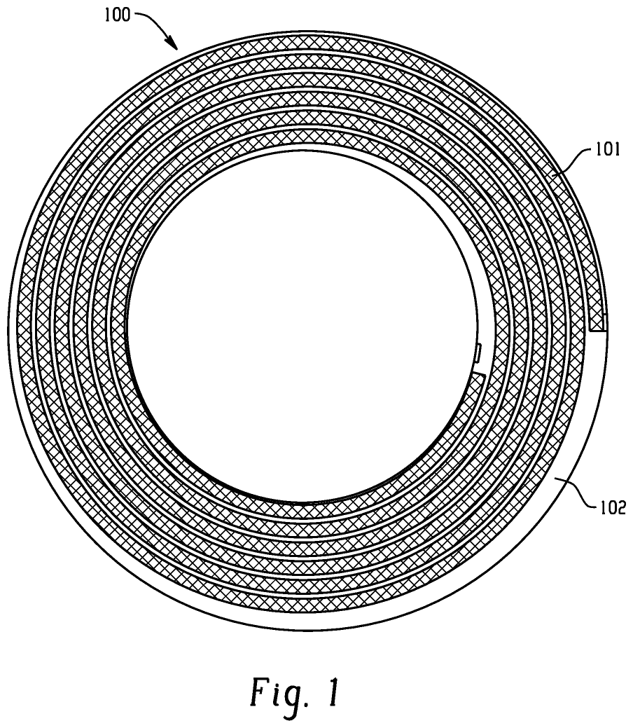

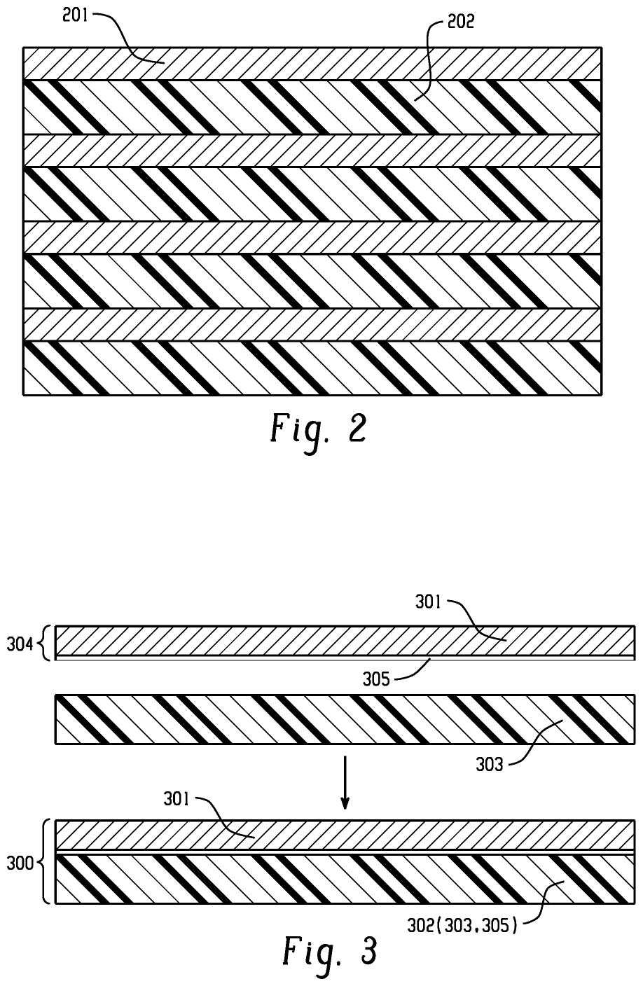

FIG. 1 shows a top view of a multilayer conductor (100) that has been wound into a spiral or coil shape, with alternating layers of patterned conductor (101) and dielectric material (102). FIG. 2 shows a cross-sectional view of a multilayer conductor coil, including alternating layer of patterned conductor (201) and dielectric material (202). While four layers of each material are shown in FIG. 2, it will be understood that the number of layers can be selected based on the identity of each layer and the corresponding material properties, the thickness of each layer, and the end-use application. A suitable number of layers can be determined by the skilled person guided by the present disclosure.

A method for the manufacture of the multilayer conductor represents another aspect of the present disclosure. The method described herein can advantageously allow for improved bonding between a conductor layer and a dielectric layer of a multilayer conductor, particularly between materials which do not typically adhere well using previously known fabrication processes.

The method according to the present disclosure can be as shown in FIG. 3. The method comprises applying a coating composition to a conductor layer. The coating composition comprises a polymer composition and a solvent. The polymer composition has a dissipation factor (Df) of less than 0.001 and comprises a cyclic olefin copolymer, a transoctenamer rubber, syndiotactic polystyrene, a polymethylpentene olefin copolymer, or a combination thereof. All variations of the polymer composition discussed previously for the dielectric layer apply to the polymer composition of the present coating composition as well.

The solvent comprises an organic solvent capable of dissolving the polymer composition. Suitable solvents can be selected by the skilled person based on the chemical composition of the polymer composition and guided by the present disclosure. Exemplary solvents for providing the coating composition can include, but are not limited to, aromatic hydrocarbon solvents such as toluene, xylene, and the like. In an aspect, the solvent is toluene.

The coating composition can comprise the polymer composition in an amount of 1 to 50 weight percent, or 5 to 40 weight percent, or 5 to 30 weight percent, or 5 to 20 weight percent, or 5 to 15 weight percent, based on the total weight of the coating composition. Conversely, the solvent can be present in the coating composition in an amount of 50 to 99 weight percent, or 60 to 95 weight percent, or 70 to 95 weight percent, or 80 to 95 weight percent, or 85 to 95 weight percent, each based on the total weight of the coating composition.

The coating composition can optionally further comprise one or more additives, for example a reactive monomer, a free radical source, or both. A reactive monomer and a free radical source can be included when crosslinking may be desired after the coating composition has been deposited on the conductor.

Applying the coating composition to the conductor layer can be by any suitable coating technique, for example including dip coating, spin coating, drop casting, doctor blading, slot die coating, and the like. In a specific aspect, applying the coating composition to the conductor layer can be by slot die coating.

The conductor can be any suitable conductive material and can preferably comprise copper or aluminum. In an aspect, the conductor comprises copper.

Following application of the coating composition onto the conductor (301), the method comprises removing the solvent to provide a coated conductor. As shown in FIG. 3, the coated conductor (304) comprises the conductor (301) having a surface that is at least partially coated with the polymer composition (305) (which is in the form of a thin layer after removal of the solvent). In an aspect, the coated conductor can comprise the polymer composition disposed thereon at a thickness of 5 to 25 micrometers, for example 6 to 25 micrometers.

As shown in FIG. 3, the coated conductor (304) is contacted with a dielectric layer (302) to provide a multilayer conductor (300) comprising the conductor layer (301) and the dielectric layer (302) (which is understood to comprise a combination of the polymer composition coating (305) and the dielectric layer (303)), wherein the coated surface of the coated conductor directly contacts the dielectric layer. In an aspect, a coated conductor can be contacted with each side of a dielectric layer (i.e., two coated conductors contacting a dielectric layer to form a sandwich structure). The coated surface of each coated conductor directly contacts the dielectric layer.

Preferably, the dielectric layer comprises the same polymer composition as the coating composition. Without wishing to be bound by theory, it is believed that the precoating step with the coating composition enables the improved adhesion of the particular dielectric layers described herein. For example, the interface between the conductor layer and the dielectric layer can have a peel strength of at least 5 pounds of force per linear inch (PLI).

Contacting the coated conductor with the dielectric layer can comprise, in an aspect, laminating the coated conductor to the dielectric layer. The laminating can be under heat and/or pressure and for an amount of time sufficient to laminate the coated conductor to the dielectric layer. For example, laminating the coated conductor to the first dielectric layer can be, for example, at a pressure of 50 to 200 pounds per square inch (PSI; 0.34 to 1.38 megapascals (MPa)), or 50 to 150 PSI (0.34 to 1.03 MPa), or 75 to 125 PSI (0.52 to 0.86 MPa), or 100 to 110 PSI (0.69 to 0.76 MPa); a temperature of 100 to 500° F. (37.8 to 260° C.), or 200 to 400° F. (93.3 to 204.4° C.), or 300 to 400° F. (148.9 to 204.4° C.), or 350 to 375° F. (176.7 to 190.6° C.), and for a time of 1 to 60 minutes, or 10 to 45 minute, or 15 to 45 minutes, or 20 to 40 minutes, or 25 to 35 minutes.

The method can comprise repeating the applying and contacting steps to provide a multilayer conductor having a predetermined number of layers, with the conductor and dielectric layers arranged in an alternating manner.

In another advantageous feature, the multilayer conductor does not comprise any material having a dielectric breakdown strength that is less than the dielectric breakdown strength of the polymer composition (e.g., the dielectric layer). For example, the multilayer conductor preferably does not have any air gaps between the conductor and the dielectric layer, which can lead to reduced performance.

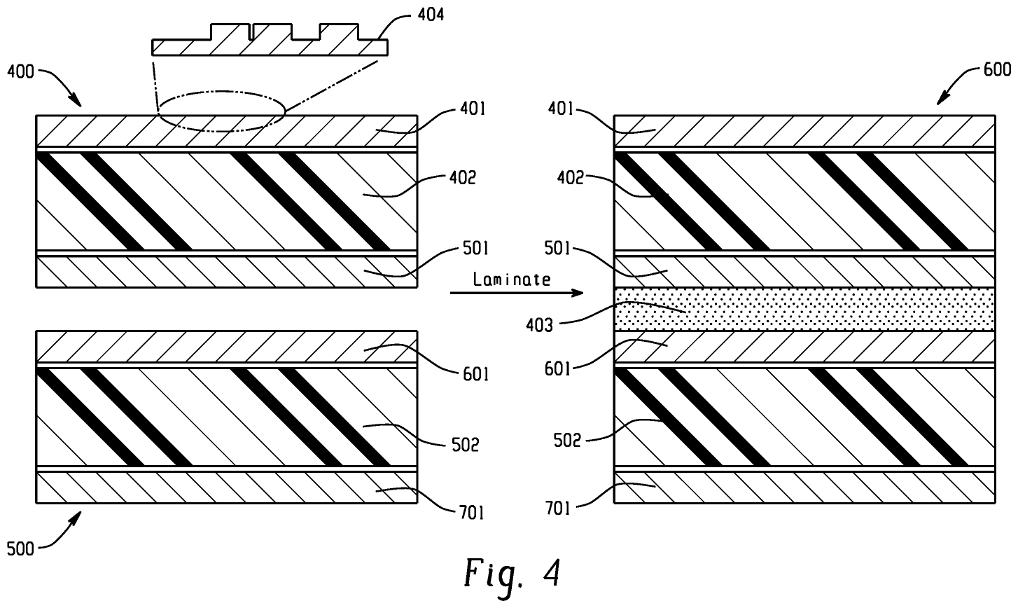

Referring to FIG. 4, in an aspect, the method described herein can be used to provide a first multilayer conductor (400) comprising a first dielectric layer (402) having a coated conductor (401, 501) disposed on each side of the first dielectric layer (i.e., forming a sandwich-type multilayer structure having the layers arranged in the following order: conductor (401)-first dielectric layer (402)-conductor (501)). A second multilayer conductor (500) can be provided comprising a second dielectric layer (502) having a coated conductor (601, 701) disposed on each side of the second dielectric layer (i.e., forming a sandwich-type multilayer structure having the layers arranged in the following order: conductor (601)-second dielectric layer (502)-conductor (701)).

The first dielectric layer and the second dielectric layer can be the same or different. The first multilayer conductor and the second multilayer conductor can be positioned on either side of an adhesive layer (403) and laminated together to provide a multilayer stack (600) having layers arranged in the following order: conductor-first dielectric layer-conductor-adhesive-conductor-second dielectric layer-conductor). It will be understood that any suitable number of multilayer conductors can be laminated together to provide a multilayer stack having a desired number of layers.

As shown in FIG. 4, the conductors can optionally be patterned conductors, having a plurality of features (404) on an outer surface of each conductor.

In an aspect, a multilayer conductor can be formed by laminating the first and second multilayer conductors (i.e., of FIG. 4). Laminating the first and second multilayer conductors can be by laminating the adjacent conductor layers (e.g., 501 and 601) using an additional dielectric material or an adhesive (403). Preferably the spacing between conductor layers is maintained (i.e., in an aspect, the thickness of the adhesive layer (403) can be within 10% of the thickness of the dielectric layers (402, 502)).

The multilayer conductor of the present disclosure can be particularly useful in magnetic self-resonant structures (MSRS). Accordingly, an assembly comprising the multilayer conductor represents another aspect of the present disclosure. Preferably the assembly is an MSRS device.

In an aspect, the multilayer conductor can be included in an assembly comprising a magnetic core adjacent to at least a part of the multilayer conductor. The magnetic core can assist in containing the magnetic field. In an aspect, a cylindrical magnetic core can be disposed in a center of a multilayer conductor that has been wound into a spiral or coil shape. In an aspect, the multilayer conductor comprises a plurality of the conductor layers and the dielectric layers arranged concentrically around a common axis, wherein the conductor layers and the dielectric layers are arranged in an alternating manner. The magnetic core can further include a center post, and the common axis forms a loop around the center post and around a center axis of the multilayer conductor. The multilayer conductor may be in a toroidal or cylindrical shape in some aspects. The assembly can further comprise an alternating current electric power source electrically coupled to at least one of the conductor layers of the multilayer conductor. Such assemblies can be particularly useful in wireless power transfer applications.

This disclosure is further illustrated by the following examples, which are non-limiting.

### EXAMPLES

### Examples 1-19: Dielectric Characterization of Polymer Compositions

Materials used in the following Examples are described in Table 1.

TABLE 1

| Component | Chemical Description | Supplier |
|---|---|---|
| COC1 | Cyclic Olefin Copolymer obtained as | TOPAS |
| | TOPAS 5013S-04 | Advance |
| | | Polymers |
| COC2 | Cyclic Olefin Copolymer obtained as | TOPAS |
| | TOPAS 6015S-04 | Advance |
| | | Polymers |
| COC3 | Cyclic Olefin Copolymer obtained as | TOPAS |
| | TOPAS 6013M-07 | Advance |
| | | Polymers |
| COC4 | Cyclic Olefin Copolymer obtained as | TOPAS |
| | TOPAS ELASTOMER E-140 | Advance |
| | | Polymers |
| TOR | Transoctenamer rubber obtained | Evonik |
| | as VESTENAMER 8012 | |
| PS-GF | Syndiotactic polystyrene with | Idemitsu |
| | 15% glass fiber filler by weight, | |
| | obtained as XAREC SP140 | |
| PMP | Polymethylpentene olefin copolymer, | Mitsui |
| | obtained as TPX MX002 | |
| PPS | Polyphenylene sulfide, obtained as | Solvay |
| | Ryton QA-200P | |
| PP-GF | Homopolypropylene with 40% long glass | Asahi |
| | fiber by weight, obtained as | |
| | THERMYLENE P6-40FG-0100 | |
| PP | Polypropylene obtained as Pinnacle | Pinnacle |
| | Polymers 2180H | Polymers, |
| | | LLC |
| PPE | Polyphenylene ether resin obtained | The Resin |
| | as TEMPPECLEAR | Enterprise, |
| | | Inc. |
| PEEK | Polyetheretherketone obtained as | Solvay |
| | Ketaspire KT-880P | |
| PPE/ | Polyphenylene ether/high impact | SABIC |
| HIPS-GF | polystyrene blend with 15% glass fibers, | |
| | obtained as NORYL NHP9023 | |
| PSU | Polysulfone obtained as UDEL P1700 | Solvay |
| PEI-Si | Polyetherimide-siloxane copolymer, | SABIC |
| | obtained as SILTEM STM1500 | |
| PEI | Polyetherimide, obtained as ULTEM 1000 | SABIC |
| ABS | Acrylonitrile Butadiene Styrene, | INEOS |
| | obtained as TERLURAN GP22 | Styrolution |
| | | Group |
| | | GmbH |
| TPI | Thermoplastic Polyimide, obtained | SABIC |
| | as EXTEM XH1015 | |
| PBT | Polybutylene terephthalate, obtained | SABIC |
| | as VALOX 325 | |
| LCP | Liquid crystal polymer having a melting | Seyang |
| | point of 330° C., obtained as L600BB | Polymer |

The electrical properties of the Table I materials were tested and are presented in Table 2. The electrical testing was conducted at 1 MHZ. The dielectric breakdown for each material is also provided in Table 2.

TABLE 2

| | | | D_{K}, | D_{F}, | | | Total | Dielectric |
|---|---|---|---|---|---|---|---|---|
| | | Thickness | 1 | 1 | Tg | Thickness | Voltage | Breakdown |
| Ex. | Component | for D_{K} (in) | MHz | MHz | (° C.) | for DS (mil) | (kV) | (V/mil) |
| 1 | COC1 | 0.0615 | 2.33 | 0.0003 | 130 | 17.8 | 21.63 | 1215 |
| 2 | COC2 | 0.0664 | 2.34 | 0.0003 | 150 | 17 | 23.45 | 1379 |
| 3 | COC3/COC4 | 0.0575 | 2.32 | 0.0003 | | 17.6 | 21.64 | 1230 |
| | (90:10) | | | | | | | |
| 4 | COC4/TOR | 0.0594 | 2.30 | 0.0005 | 6/−90 | 17.9 | 19.05 | 1064 |
| | (70:30) | | | | | | | |
| 5 | PS-GF | 0.062 | 3.00 | 0.0007 | 95 | 17.3 | 17.2 | 996 |
| 6 | PMP | 0.0595 | 2.14 | 0.0009 | 93 | 18 | 23.17 | 1287 |
| 7* | PPS | 0.123 | 3.25 | 0.0010 | 90 | 15.4 | 17.75 | 1153 |
| 8* | PP-GF | 0.0641 | 2.80 | 0.0011 | −20 | 20.9 | 11.45 | 548 |
| 9* | PP | 0.0554 | 2.22 | 0.0011 | −5 | 16.7 | 20.01 | 1198 |
| 10* | PPE | 0.0642 | 2.59 | 0.0012 | 160-180 | 25.7 | 22.83 | 888 |
| 11* | PEEK | 0.0572 | 3.21 | 0.0029 | | 57.2 | 22.95 | 401 |
| 12* | PPE/HIPS-GF | 0.0616 | 2.70 | 0.0035 | | 61.6 | 19.87 | 323 |
| 13* | PSU | 0.0633 | 3.05 | 0.0045 | | 63.3 | 24.33 | 384 |
| 14* | PEI-Si | 0.1328 | 2.96 | 0.0057 | | | NA | |
| 15* | PEI | 0.123 | 3.14 | 0.0066 | | | NA | |
| 16* | ABS | 0.0635 | 2.79 | 0.0088 | 104 | 63.5 | 26.49 | 417 |
| 17* | TPI | 0.1311 | 3.52 | 0.0127 | | | NA | |
| 18* | PBT | 0.0555 | 3.12 | 0.0177 | | 55.5 | 22.09 | 398 |
| 19* | LCP | 0.0564 | 3.24 | 0.0401 | | 56.4 | 24.52 | 435 |

*indicates a comparative example

As seen in Table 2, compositions according to Examples 1-6 each exhibited a Df of less than 0.001 at 1 MHz. These materials will be useful as dielectric materials, particularly for magnetic self-resonant structure (MSRS) devices operating at low frequencies.

### Examples 20-21: Methods of Bonding Dielectric Layers to a Conductor

The COC1 material was used to further demonstrate a method for improving the adhesion of the polymer material to a conductor (e.g., copper). Standard copper foil alone cannot be bonded directly to COC1. Adhesion was enabled using these materials using two methods.

### Example 20

In a first method of bonding, the copper foil was first coated with a dilute solution of COC1 in toluene at 10 weight percent solids using a knife over roll coating method to obtain an 8 micrometer thick film of COC1 on the surface of the copper foil. The COC1-coated copper was then bonded to a 20-mil (0.5-millimeter) thick layer of COC1 by laminating at 100 PSI (0.69 MPa), at a temperature of 360° F. (182° C.), for 30 minutes. The resulting composite exhibited a bond strength of 8.2 PLI (1.4 kilonewtons per meter) as determined using a 90-degree peel tester.

### Example 21

In a second method of bonding, the copper foil was coated with a dilute solution of a formulated composition in toluene at 10 weight percent solids using knife over roll coating method to obtain an 8-micrometer thick film of formulated composition on the surface of the copper foil. The formulated composition comprises COC1; a reactive monomer which is free-radically cross linkable (e.g., a bismaleimide, styrene-butadiene deblock or triblock copolymer, zinc dimethacrylate, thio-ene combinations such as 1,3,5-triallyl-1,3,5-triazine-2,4,6 (1H,3H,5H)-trione (TATATO) or pentaerythritoltetra (3-mercaptopropionate (PETMP)) and a free radical source initiator (e.g., a peroxide, such as 2,5-dimethyl-2,5-di (tertbutylperoxy) hexyne-3 (DYBP)) at 8:2:0.1 ratio. A coagent can also be present, for example triallyl isocyanurate (TAIC). The formulated composition coated copper foil was bonded to a 20-mil (0.5-millimeter) thick COC1 layer by laminating at 100 PSI (0.69 MPa), at a temperature of 360° F. (182° C.), for 30 minutes. The resulting composite exhibited a bond strength of 10.8 PLI (1.9 kilonewtons per meter), as determined by a 90-degree peel tester.

These methods produced composites that were tested for bond strength. If a precoating step is omitted a testable sample cannot be produced as the adhesion between copper and COC1 is not sufficient (i.e., the copper does not adhere to the COC1).

This disclosure further encompasses the following aspects.
Aspect 1: A multilayer conductor comprising a conductor layer and a dielectric layer on the conductor layer, wherein the dielectric layer comprises a polymer composition having a dissipation factor (Df) of less than 0.001 and comprising a cyclic olefin copolymer, a transoctenamer rubber, syndiotactic polystyrene, a polymethylpentene olefin copolymer, or a combination thereof; and wherein an interface between the conductor layer and the dielectric layer has a peel strength of at least 5 pounds of force per linear inch (PLI) (0.88 kilonewtons per meter).
Aspect 2: The multilayer conductor of aspect 1, comprising at least two conductor layers and a dielectric layer, wherein the conductor layers and dielectric layer are arranged in an alternating manner.
Aspect 3: The multilayer conductor of aspect 1 or 2, wherein the dielectric layer further comprises a reinforcing agent, preferably wherein the reinforcing agent comprises a reinforcing filler, woven fiberglass, or nonwoven fiberglass.
Aspect 4: The multilayer conductor of any of aspects 1 to 3, wherein the dielectric layer comprises a crosslinked portion at an interface of the dielectric layer and the conductor layer.
Aspect 5: The multilayer conductor of aspect 4, wherein the crosslinked portion extends up to 25 micrometers into the dielectric layer from the interface.
Aspect 6: The multilayer conductor of any of aspects 1 to 5, wherein the dielectric layer comprises the cyclic olefin copolymer.
Aspect 7: The multilayer conductor of any of aspects 1 to 6, wherein the dielectric layer comprises a first cyclic olefin copolymer and a second cyclic olefin copolymer, preferably wherein the first cyclic olefin copolymer and the second cyclic olefin copolymer are present in a weight ratio of 1:99 to 99:1, or 5:95 to 95:5.
Aspect 8: The multilayer conductor of any of aspects 1 to 7, wherein the dielectric layer comprises the transoctenamer rubber.
Aspect 9: The multilayer conductor of any of aspects 1 to 8, wherein the dielectric layer comprises the cyclic olefin copolymer and the transoctenamer rubber, preferably in a weight ratio of cyclic olefin copolymer:transoctenamer rubber of 10:90 to 90:10, or 50:50 to 90:10, or 60:40 to 80:20, or 65:35 to 75:25.
Aspect 10: The multilayer conductor of any of aspects 1 to 9, wherein the dielectric layer comprises the syndiotactic polystyrene.
Aspect 11: The multilayer conductor of aspect 10, wherein the dielectric layer further comprises a reinforcing filler comprises glass fibers, more preferably wherein the reinforcing filler is present in an amount of 1 to 30 weight percent, or 5 to 25 weight percent, or 10 to 20 weight percent, based on the total weight of the dielectric layer.
Aspect 12: The multilayer conductor of any of aspects 1 to 11, wherein the dielectric layer comprises the polymethylpentene olefin copolymer.
Aspect 13: A method for the manufacture of the multilayer conductor of any of aspects 1 to 12, the method comprising: applying a coating composition comprising the polymer composition and a solvent to the conductor layer; removing the solvent to provide a coated conductor having a surface coated with the polymer composition; contacting the coated conductor with the dielectric layer; wherein the dielectric layer comprises the same polymer composition as the coating composition.
Aspect 14: The method of aspect 13, further comprising repeating the applying and contacting to provide a multilayer conductor having a predetermined number of layers with the conductor and dielectric layers arranged in an alternating manner.
Aspect 15: The method of aspects 13 or 14, comprising applying the coating composition to the conductor layer by slot die coating.
Aspect 16: The method of any of aspects 13 to 15, wherein contacting the surface of the conductor layer coated with the polymer composition with the dielectric layer comprises laminating the conductor layer to the dielectric layer.
Aspect 17: The method of any of aspects 13 to 16, wherein the coating composition further comprises a reactive monomer, a free radical source, or both.
Aspect 18: The method of any of aspects 13 to 17, wherein the conductor comprises copper, or aluminum.
Aspect 19: The method of any of aspects 13 to 18, wherein the conductor layer comprises the polymer composition at a thickness of 6 to 25 micrometers.
Aspect 20: The method of any of aspects 13 to 19, wherein the multilayer conductor does not have air gaps between the conductor and the dielectric layer.
Aspect 21: The method of any of aspects 13 to 20, wherein the dielectric layer comprises a crosslinked portion at an interface of the dielectric layer and the conductor layer, wherein the crosslinked portion extends up to 25 micrometers into the dielectric layer from the interface.
Aspect 22: The method of any of aspects 13 to 21, wherein an interface between the conductor layer and the dielectric layer has a peel strength of at least 5 pounds of force per linear inch (PLI) (0.88 kilonewtons per meter).
Aspect 23: An assembly comprising: the multilayer conductor of any of aspects 1 to 12; and a magnetic core adjacent to at least part of the multilayer conductor.
Aspect 24: The assembly of aspect 23, wherein the multilayer conductor comprises a plurality of the conductor layers and the dielectric layers arranged concentrically around a common axis, wherein the conductor layers and the dielectric layers are arranged in an alternating manner.
Aspect 25: The assembly of aspect 24, wherein the magnetic core includes a center post, and the common axis forms a loop around the center post and around a center axis of the multilayer conductor.
Aspect 26: The assembly of any of aspects 23 to 25, wherein the multilayer conductor has a toroidal shape.
Aspect 27: The assembly of any of aspects 23 to 25, wherein the multilayer conductor has a cylindrical shape.
Aspect 28: The assembly of any of aspects 23 to 27, further comprising an alternating current electric power source electrically coupled to at least one of the conductor layers of the multilayer conductor.
Aspect 29: The assembly of any of aspects 23 to 28, wherein the assembly is a magnetic self-resonant structure.

The compositions, methods, and articles can alternatively comprise, consist of, or consist essentially of, any appropriate materials, steps, or components herein disclosed. The compositions, methods, and articles can additionally, or alternatively, be formulated so as to be devoid, or substantially free, of any materials (or species), steps, or components, that are otherwise not necessary to the achievement of the function or objectives of the compositions, methods, and articles.

All ranges disclosed herein are inclusive of the endpoints, and the endpoints are independently combinable with each other. “Combinations” is inclusive of blends, mixtures, alloys, reaction products, and the like. The terms “first,” “second,” and the like, do not denote any order, quantity, or importance, but rather are used to distinguish one element from another. The terms “a” and “an” and “the” do not denote a limitation of quantity, and are to be construed to cover both the singular and the plural, unless otherwise indicated herein or clearly contradicted by context. “Or” means “and/or” unless clearly stated otherwise. Reference throughout the specification to “an aspect” means that a particular element described in connection with the aspect is included in at least one aspect described herein, and may or may not be present in other aspects. The term “combination thereof” as used herein includes one or more of the listed elements, and is open, allowing the presence of one or more like elements not named. In addition, it is to be understood that the described elements may be combined in any suitable manner in the various aspects.

It will be understood that when an element is referred to as being “on” another element or “in contact” with another element, it can be directly on the other element or intervening elements may be present therebetween, unless explicitly stated otherwise. In contrast, when an element is referred to as being “directly on” or “directly in contact with” another element, there are no intervening elements present.

Exemplary embodiments are described herein with reference to cross section illustrations that are schematic illustrations of idealized embodiments. As such, variations from the shapes of the illustrations as a result, for example, of manufacturing techniques and/or tolerances, are to be expected. Thus, embodiments described herein should not be construed as limited to the particular shapes of regions as illustrated herein but are to include deviations in shapes that result, for example, from manufacturing. For example, a region illustrated or described as flat may, typically, have rough and/or nonlinear features. Moreover, sharp angles that are illustrated may be rounded. Thus, the regions illustrated in the figures are schematic in nature and their shapes are not intended to illustrate the precise shape of a region and are not intended to limit the scope of the present claims.

Unless specified to the contrary herein, all test standards are the most recent standard in effect as of the filing date of this application, or, if priority is claimed, the filing date of the earliest priority application in which the test standard appears.

Unless defined otherwise, technical and scientific terms used herein have the same meaning as is commonly understood by one of skill in the art to which this application belongs. All cited patents, patent applications, and other references are incorporated herein by reference in their entirety. However, if a term in the present application contradicts or conflicts with a term in the incorporated reference, the term from the present application takes precedence over the conflicting term from the incorporated reference.

Compounds are described using standard nomenclature. For example, any position not substituted by any indicated group is understood to have its valency filled by a bond as indicated, or a hydrogen atom. A dash (“-”) that is not between two letters or symbols is used to indicate a point of attachment for a substituent. For example, —CHO is attached through carbon of the carbonyl group.

While particular embodiments have been described, alternatives, modifications, variations, improvements, and substantial equivalents that are or may be presently unforeseen may arise to applicants or others skilled in the art. Accordingly, the appended claims as filed and as they may be amended are intended to embrace all such alternatives, modifications variations, improvements, and substantial equivalents.

1. A multilayer conductor comprising a conductor layer and a dielectric layer on the conductor layer,
wherein the dielectric layer comprises a polymer composition having a dissipation factor (Df) of less than 0.001 and comprising a cyclic olefin copolymer, a transoctenamer rubber, syndiotactic polystyrene, a polymethylpentene olefin copolymer, or a combination thereof; and
wherein an interface between the conductor layer and the dielectric layer has a peel strength of at least 5 pounds of force per linear inch (PLI) (0.88 kilonewtons per meter).

2. The multilayer conductor of claim 1, comprising at least two conductor layers, wherein the conductor layers and dielectric layer are arranged in an alternating manner.

3. The multilayer conductor of claim 1, wherein the dielectric layer further comprises a reinforcing agent.

4. The multilayer conductor of claim 1, wherein the dielectric layer comprises a crosslinked portion at an interface of the dielectric layer and the conductor layer, wherein the crosslinked portion extends up to 25 micrometers into the dielectric layer from the interface.

5. The multilayer conductor of claim 1, wherein the dielectric layer comprises the cyclic olefin copolymer.

6. The multilayer conductor of claim 1, wherein the dielectric layer comprises a first cyclic olefin copolymer and a second cyclic olefin copolymer.

7. The multilayer conductor of claim 1, wherein the dielectric layer comprises the transoctenamer rubber.

8. The multilayer conductor of claim 1, wherein the dielectric layer comprises the cyclic olefin copolymer and the transoctenamer rubber.

9. The multilayer conductor of claim 1, wherein the dielectric layer comprises the syndiotactic polystyrene, and optionally a reinforcing filler comprising glass fibers.

10. The multilayer conductor of claim 1, wherein the dielectric layer comprises the polymethylpentene olefin copolymer.

11. A method for the manufacture of the multilayer conductor of claim 1, the method comprising:
applying a coating composition comprising
the polymer composition,
a solvent, and
optionally, a reactive monomer, a free radical source, or both,
to the conductor layer;
removing the solvent to provide a surface of the conductor layer coated with the polymer composition; and
contacting the surface of the conductor layer coated with the polymer composition with the dielectric layer;
wherein the dielectric layer comprises the same polymer composition as the coating composition.

12. The method of claim 11, further comprising repeating the applying and contacting to provide a multilayer conductor having a predetermined number of layers with the conductor and dielectric layers arranged in an alternating manner.

13. The method of claim 11, comprising applying the coating composition to the conductor layer by slot die coating.

14. The method of claim 11, wherein contacting the surface of the conductor layer coated with the polymer composition with the dielectric layer comprises laminating the conductor layer to the dielectric layer.

15. The method of claim 11, wherein the conductor layer comprises the polymer composition at a thickness of 6 to 25 micrometers.

16. The method of claim 11, wherein the multilayer conductor does not have air gaps between the conductor and the dielectric layer.

17. The method of claim 11, wherein the dielectric layer comprises a crosslinked portion at an interface of the dielectric layer and the conductor layer, wherein the crosslinked portion extends up to 25 micrometers into the dielectric layer from the interface.

18. The method of claim 11, wherein an interface between the conductor layer and the dielectric layer has a peel strength of at least 5 pounds of force per linear inch (PLI) (0.88 kilonewtons per meter).

19. An assembly comprising:
the multilayer conductor of claim 1; and
a magnetic core adjacent to at least part of the multilayer conductor.

20. The assembly of claim 19, wherein the multilayer conductor comprises a plurality of the conductor layers and the dielectric layers arranged concentrically around a common axis, wherein the conductor layers and the dielectric layers are arranged in an alternating manner.

21. The assembly of claim 19, wherein the magnetic core includes a center post, and the common axis forms a loop around the center post and around a center axis of the multilayer conductor.

22. The assembly of claim 19, wherein the multilayer conductor has a toroidal shape or a cylindrical shape.

23. The assembly of claim 19, further comprising an alternating current electric power source electrically coupled to a conductor layer of the multilayer conductor.

24. The assembly of claim 19, wherein the assembly is a magnetic self-resonant structure.
